(19) United States
(12) Patent Application Publication
(10) Pub. No.: US 2018/0131100 A1
(43) Pub. Date: May 10, 2018

(54) LEFT-HANDED CIRCULAR-POLARIZATION CONVERSION METAMATERIAL FILM

(71) Applicant: Zhengbiao Ouyang, Shenzhen (CN)

(72) Inventors: Zhengbiao Ouyang, Shenzhen (CN); Quanqiang Yu, Shenzhen (CN); Yogesh N•, Shenzhen (CN)

(21) Appl. No.: 15/862,147

(22) Filed: Jan. 4, 2018

Related U.S. Application Data
(63) Continuation of application No. PCT/CN2016/092406, filed on Jul. 29, 2016.

(30) Foreign Application Priority Data
Aug. 3, 2015 (CN) 201510484126.5

(51) Int. Cl. H01Q 15/00; G02B 27/28; G02B 5/30; H01P 1/17; H01Q 15/24

(52) U.S. Cl. CPC H01Q 15/0086; G02B 27/286; G02B 5/3008; G02B 27/285; G02B 5/3066; H01Q 15/244; H01P 1/17

(57) ABSTRACT

The present invention discloses a left-handed circular-polarization conversion metamaterial film, and is of an optical frequency band metamaterial structure, comprising a first metal microstructure layer, a dielectric substrate layer and a second metal microstructure layer, wherein the first and the second metal microstructure layers are attached to the two sides of the dielectric substrate layer; an upper surface of the first metal microstructure layer is an incident surface; the lower surface of the second metal microstructure layer is an exit surface; the first and the second metal microstructure layers are of chirally-symmetric right-handed windmill structures or spiral chirally-symmetric right-handed artificial structures, left-hand-rotated angle using the structure center as a rotation center is formed between the first and the second metal microstructure layers, the amplitudes of two orthogonal components of output light waves are equal, and a phase difference of the two orthogonal components is odd times of 90 degrees.

### CROSS-REFERENCE TO RELATED APPLICATIONS

This application claims priority to Chinese Application No. 201510484126.5 filed on Aug. 3, 2015 and Continuation of Application No. PCT/CN2016/092406 filed on Jul. 29, 2016 and published in Chinese as International Publication No. WO2017020792 on Feb. 9, 2017, the entire contents of which are hereby incorporated by reference.

### FIELD OF THE INVENTION

The present invention relates to the field of optical communications, and more specifically, relates to a left-handed circular-polarization conversion metamaterial film.

### BACKGROUND OF THE INVENTION

Wave fields vibrate in different directions during propagation, this vibration is referred to as polarization of waves including light waves, and it is an inherent property of waves. For example, electromagnetic waves, acoustic waves, gravitational waves and the like all have polarization properties, but the polarization properties of various waves are different, e.g., the polarization direction of acoustic waves is consistent with the propagation direction thereof, and such waves having consistent polarization direction and propagation direction are often referred to as longitudinal waves. The waves having the polarization direction perpendicular to the propagation direction are referred to as transverse waves. Electromagnetic waves are typical transverse waves, having polarization of electric and magnetic fields and the polarization direction perpendicular to the propagation direction, and the polarization direction of the electric field is often defined as the polarization direction of the electromagnetic waves. Polarization is an indispensable parameter in many scientific research fields, e.g., optics, microwaves, radio engineering, and seismology. Similarly, the research on polarization is also a vital link in the technical application fields, e.g., laser communication, wireless communication, optical fiber communication, and radar.

The polarization rotator is also referred to as a polarization converter, and is a device for changing the signal polarization state. The signal polarization state is mainly changed via a wave plate or a Faraday rotator nowadays.

The wave plate is an optical device enabling light waves with mutually vertical light vibrations to generate an additional phase difference, and is often prepared from some uniaxial crystals with birefringence, e.g., quartz, mica, and calcite. When light waves pass through the wave plate having certain thickness, the o light (ordinary light) and e light (extra-ordinary light) of the light waves obtain a certain phase difference at exiting due to different propagation speeds in the wave plate for the two kinds of light, the polarization state will be changed after the light waves exit and are synthesized, and the change of the polarization state depends on the phase difference generated after the light waves pass through the wave plate. Generally, the wave plate capable of generating a ¼ wavelength phase difference is referred to as a quarter wave plate; and the wave plate capable of generating a ½ wavelength phase difference is referred to as a half wave plate. If incident light waves are linearly polarized light and the light waves pass through the quarter wave plate at a certain angle, the emergent light waves are changed into circularly polarized light; and similarly, if the linearly polarized light waves pass through the half wave plate at a certain angle, the emergent light waves are still linearly polarized light, but its polarization angle is often changed.

The Faraday rotator is a magneto-optical rotation device based on Faraday Effect. After linearly polarized light passes through a crystal with an external magnetic field, the polarization surface of light waves will rotate, and this phenomenon is referred to as Faraday Effect. This crystal is referred to as magneto-optical crystal. The rotating angle θ of the polarization surface of the emergent light waves is directly proportional to the magnetic induction intensity B of the external magnetic field and the acting distance L of the light waves in the crystal:

θ=VBL

wherein V is a Verdet constant and is the inherent property of the magneto-optical crystal.

Wave plates can be divided to multiple-order wave plates, composite wave plates and true zero-order wave plates according to structures. However, each wave plate itself has shortcomings, e.g., wavelength sensitivity, temperature sensitivity, incident angle sensitivity or difficulty in manufacturing. The Faraday rotator has the problems of poor temperature characteristic, prominent light attenuation, high insertion loss, low control precision, large size and the like.

The beam polarization state conversion realized by the present invention does not adopt the traditional conversion technology, e.g., the wave plate or the Faraday rotator, whereas the beam polarization state is modulated via a metamaterial technology.

The metamaterial is an artificial structured functional material, and has some special functions that cannot be achieved by the materials in nature. The metamaterial is not a “material” understood in the conventional sense, and it can realize supernormal material functions not owned by inherent materials in nature via ordered design and arrangement of a structure having certain physical dimension. Therefore, the metamaterial can also be understood as an artificial composite material. Since current printed circuit manufacturing process has been very mature and has a great advantage for manufacturing a microwave band metamaterial, the research on microwave band metamaterial application devices has become a hotspot. With continuous development of modern manufacturing process, the semiconductor process has been developed from the submicron era to the nano-electronic era. The physical dimension of the metamaterial can reach the nano scale via modern manufacturing process, so the development of the light wave band metamaterial also increasingly becomes the focus of scientific researches.

### SUMMARY OF THE INVENTION

The present invention overcomes the defects in the prior art, and provides a metamaterial film having a simple structure, high conversion efficiency and a function of converting linearly polarized light into right-handed circularly-polarized light.

The technical proposal adopted by the invention to solve the technical problem is as follows:

A left-handed circular-polarization conversion metamaterial film of the present invention is of an optical frequency band metamaterial structure, and includes a first metal microstructure layer 1, a dielectric substrate layer 2 and a second metal microstructure layer 3, wherein the first metal microstructure layer 1 and the second metal microstructure layer 3 are attached to the two sides of the dielectric substrate layer 2; an upper surface of the first metal microstructure layer 1 is a first metal surface 1 and a lower surface is a second metal surface 2; the upper surface of the second metal microstructure layer 3 is a third metal surface 3 and the lower surface is a fourth metal surface 4, the first metal surface 1 is an incident surface, and the fourth metal surface 4 is an exit surface; the first metal microstructure layer 1 and the second metal microstructure layer 3 are of chirally-symmetric right-handed windmill structures or spiral chirally-symmetric right-handed artificial structures, left-hand-rotated angle using the structure center as a rotation center is formed between the first metal microstructure layer 1 and the second metal microstructure layer 3, the amplitudes of two orthogonal components of output light wave are equal, and a phase difference of the two orthogonal components is odd times of 90 degrees.

Both the first metal microstructure layer 1 and the second metal microstructure layer 3 are included of a plurality of right-handed gammadion microstructures arranged periodically in an array manner.

The first metal microstructure layer 1 and the second metal microstructure layer 3 are made of a metallic conductive material or a nonmetallic conductive material.

The metallic conductive material is gold, silver or copper.

The nonmetallic conductive material is an indium tin oxide or graphite carbon nano-tubes.

The thicknesses of both the first metal microstructure layer 1 and the second metal microstructure layer 3 are 30˜100 nm.

The dielectric substrate layer 2 is made of a polymer.

The polymer is cyanate, PMMA (Polymethyl Methacrylate), PTFE (Polytetrafluoroethylene) or fluoride.

The dielectric substrate layer 2 is made of a material having low dielectric constant and low dielectric loss, and the dielectric constant of the material is 1.5˜2.0.

A value of dielectric loss tangent of the dielectric substrate layer 2 is less than 0.003.

The dielectric thickness of the dielectric substrate layer 2 is 20˜100 nm.

The left-hand-rotated angle of the rotation center is 5˜22.5°.

Compared with the prior art, the present invention has the following advantages:

1. The metamaterial film of the nano-scale metal microstructure has a circular polarization filtering function, namely a function of filtering left-handed circularly-polarized light waves and retaining right-handed circularly-polarized light to pass.

2. A beam of linearly polarized light can be converted into right-handed circularly-polarized light, the conversion efficiency can reach over 98%, and the quality of the output beam is high.

3. The metamaterial film is simple in structural pattern, high in conversion efficiency, low in insertion loss and small in size, a novel and efficient modulation method is provided for polarization state modulation of light waves, and the novel polarization rotator has great significance and good development prospect for the development of communication technology.

4. The metamaterial film is manufactured by a self-assembly manner in the material or chemical technology or a miniature manner in the semiconductor technology.

These and other objects and advantages of the present invention will become readily apparent to those skilled in the art upon reading the following detailed description and claims and by referring to the accompanying drawings.

### BRIEF DESCRIPTION OF THE DRAWINGS

FIG. 1 is a schematic diagram of a laminated structure of a metamaterial film;

FIG. 2 is a schematic diagram of an artificial metal microstructure of the metamaterial film;

FIG. 3 is a laminated schematic diagram of two metal microstructure layers of the metamaterial film;

FIG. 4 is a schematic diagram of the metamaterial film;

FIG. 5 is a schematic diagram of transmission output results of two orthogonal components;

FIG. 6 is a schematic diagram of transmission output phases of two orthogonal components;

FIG. 7A is an output beam quality analysis diagram (transmission);

FIG. 7 B is an output beam quality analysis diagram (ellipticity);

FIG. 8A is an electromagnetic coupling diagram (Hx, front face).

FIG. 8B is an electromagnetic coupling diagram (Hx, back face).

FIG. 8C is an electromagnetic coupling diagram (Hy, front face).

FIG. 8D is an electromagnetic coupling diagram (Hy, back face).

The present invention is more specifically described in the following paragraphs by reference to the drawings attached only by way of example.

### DETAILED DESCRIPTION OF THE EMBODIMENTS

The terms a or an, as used herein, are defined as one or more than one, The term plurality, as used herein, is defined as two or more than two. The term another, as used herein, is defined as at least a second or more.

The present invention will be further elaborated below in combination with the accompanying drawings and specific embodiments.

Referring now to FIG. 1, a left-handed circular-polarization conversion metamaterial film is of an optical frequency band metamaterial structure, and includes a first metal microstructure layer 1, a dielectric substrate layer 2 and a second metal microstructure layer 3, wherein the first metal microstructure layer 1 and the second metal microstructure layer 3 are attached to the two sides of the dielectric substrate layer 2; the first metal microstructure layer 1 and the second metal microstructure layer 3 are divided into four metal surfaces, i.e., the upper surface of the first metal microstructure layer 1 is a first metal surface 1 and the lower surface is a second metal surface 2, the upper surface of the second metal microstructure layer 3 is a third metal surface 3 and the lower surface is a fourth metal surface 4, the first metal surface 1 is an incident surface of the structure, and the fourth metal surface 4 is an exit surface of the structure; the dielectric substrate layer 2 is made of a material having low dielectric constant and low material loss, such as polyfluoride, acrylic resin or the like; the first metal microstructure layer 1 and the second metal microstructure layer 3 are made of a metallic conductive material such as gold, silver or copper or a nonmetallic conductive material such as an indium tin oxide or graphite carbon nano-tubes.

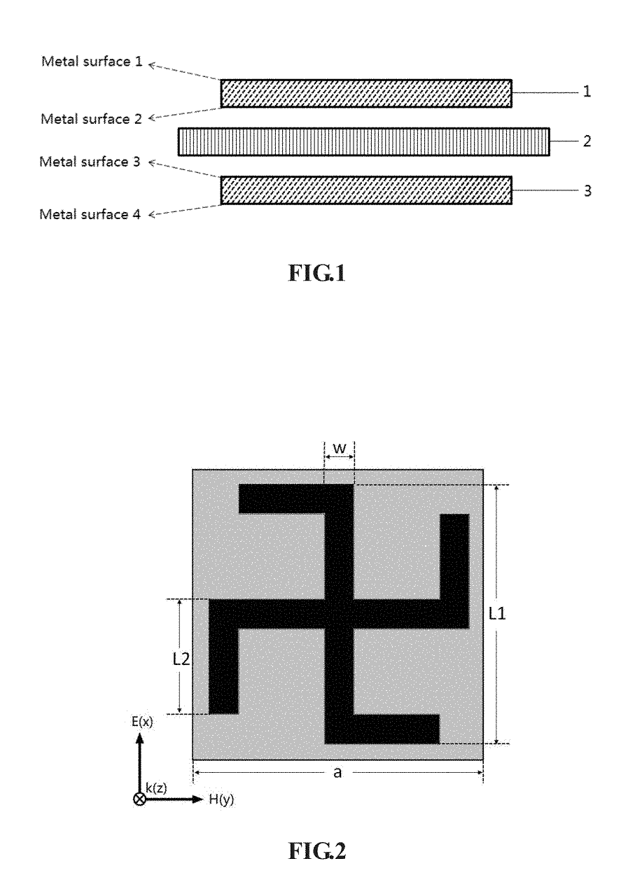

The first metal microstructure layer 1 and the second metal microstructure layer 3 of the present invention are of metal microstructures arranged periodically, the unit structure of the metal layers is shown as FIG. 2, and the metal microstructure is a right-handed windmill structure having chiral symmetry and is similar to a windmill. The structure has the line width of w, the long arm of L1 and the short arm of L2, and the unit structure has the side length of a, namely the lattice constant of the metamaterial.

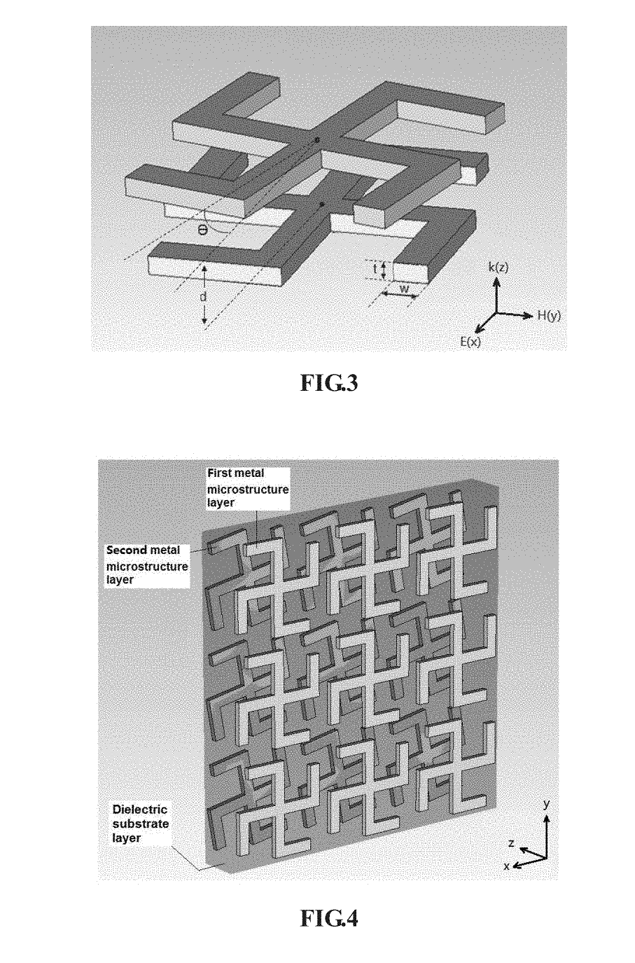

The metal microstructure lamination manner of the first metal microstructure layer 1 and the second metal microstructure layer 3 in the metamaterial unit lattice is shown as FIG. 3, the first metal microstructure layer 1 and the second metal microstructure layer 3 are not stacked oppositely, but a left-hand-rotated angle θ using the structure center as a rotation center is formed between them. As shown in FIG. 3, the metal line width is w, the metal thickness is t, the left-hand-rotated angle between the first metal microstructure layer 1 and the second metal microstructure layer 3 is θ, the distance between two corresponding metal surfaces is d, and the distance between two metal structure layers is d-t, namely the thickness of the second dielectric layer.

A microstructure unit is used as the unit cell of the metamaterial, the unit cells are arranged periodically along the X axis and the Y axis, FIG. 4 is a schematic diagram of the metamaterial of the present invention, the first metal microstructure layer 1 and the second metal microstructure layer 3 are composed of a plurality of right-handed gammadion microstructures arranged periodically in an array manner, three unit cells are arranged periodically along the X axis and the Y axis respectively, and but in practical application, more than three unit cells are arranged periodically.

Specific parameters of an embodiment given by the present invention are as follows: the line width is 40 nm, the metal thickness t is 20 nm, the metal long arm L1 is 350 nm, the metal short arm L2 is 155 nm, the laminated angle θ of two metal microstructures layer is 10°, and the metal material is gold; the material of the dielectric substrate layer adopts metal fluoride, the dielectric constant is 1.9, the magnetic conductivity is 1, the thickness is 30 nm, and the lattice constant a is 400 nm.

The metamaterial film can convert a beam of linearly polarized light wave into a beam of left-handed circularly-polarized light wave, and the output light wave of the system needs to satisfy two conditions: (1) the amplitudes of two orthogonal components of the output light wave should be equal, namely T_{xy}=T_{yy}, and (2) the phase difference of the two orthogonal components is odd times of 90 degrees.

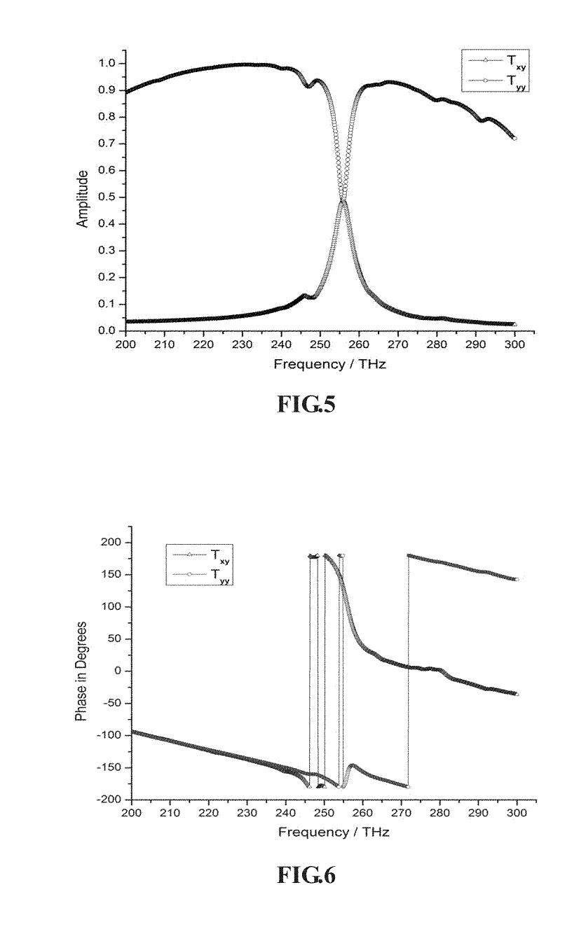

A simulation experiment is performed on the embodiment of the present invention via a finite-difference time-domain method, a beam of linearly polarized light having the polarization direction parallel to the Y axis is used as the incident light wave, the light wave passes through the metamaterial given by the embodiment of the present invention, and the output result shown in FIG. 5 is thus obtained. As shown in FIG. 5, both the horizontal component amplitude T_{xy} and the vertical component amplitude T_{yy} of the output light waves are 0.49 at the frequency of 255.9 THz in the embodiment of the present invention; and as shown in FIG. 6, the phase difference of the horizontal component and the vertical component of the output light waves is 88. 75°, about 90°, at the frequency of 255.9 THz in the embodiment of the present invention. To sum up, according to T_{xy}=T_{yy}, the phase difference is about −90°, thus, the output light is circularly-polarized light.

According to the above-mentioned output result, the output light waves can be analyzed via a Jones matrix:

$$\begin{matrix}( \begin{matrix}{E}_{+}^{t} \\ {E}_{-}^{t}\end{matrix} ) = \frac{1}{\sqrt{2}} ( \begin{matrix}{T}_{+ x} & {T}_{+ y} \\ {T}_{- x} & {T}_{- y}\end{matrix} ) ( \begin{matrix}{E}_{x}^{i} \\ {E}_{y}^{i}\end{matrix} ) , \\ ( \begin{matrix}{T}_{+ x} & {T}_{+ y} \\ {T}_{- x} & {T}_{- y}\end{matrix} ) = ( \begin{matrix}{T}_{xx} + {iT}_{yx} & {T}_{xy} + {iT}_{yy} \\ {T}_{xx} - {iT}_{yx} & {T}_{xy} - {iT}_{yy}\end{matrix} ) , & ( 1 ) \\ η = arctan \frac{\vert {E}_{+} \vert - \vert {E}_{-} \vert}{\vert {E}_{+} \vert + \vert {E}_{-} \vert} , & ( 2 )\end{matrix}$$

In formulas, E₊^{t} and E₋^{t} are respectively the transmitted electric fields of right-handed polarized light waves and left-handed polarized light waves; EX and E_{y}ⁱ are respectively the incident electric field components of linearly polarized light waves in the x and y directions; T₊ₓ(T₋ₓ) and T_{+y}(T_{-y}) are respectively incident components of the right-handed polarized light wave (left-handed polarized light wave) in the x and y directions; and η is the ellipticity of the output light wave.

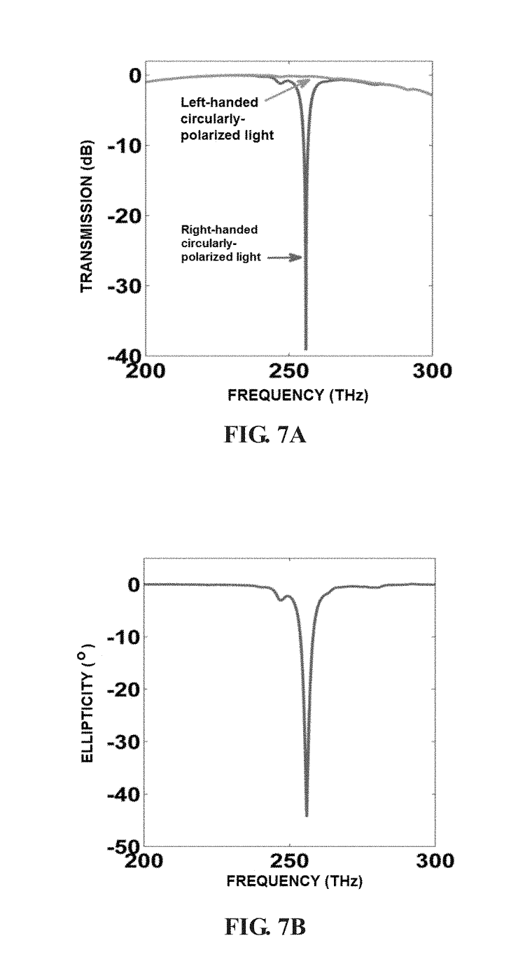

It can be obtained by calculation via Eqs. (1) and (2) above that the output light wave of the system is a beam of left-handed polarized light wave under the response frequency of 255.9 THz in the embodiment of the present invention, as shown in FIG. 7A. When the ellipticity of a beam of light wave is 45°, the light wave is a beam of circularly-polarized light; and the ellipticity of the output light wave of the system is −44.36°, as shown in FIG. 7B, so the output light waves of the system are approximately circularly-polarized light.

Generally, a beam of linearly polarized light can be regarded as being synthesized by a beam of left-handed circularly-polarized light and a beam of right-handed circularly-polarized light under certain phase condition. It can be obtained by further analysis on the output result of the embodiment of the present invention that, under the response frequency of 255.9 THz, the conversion loss of the left-handed circularly-polarized light is −0.186 dB, and the conversion loss of the right-handed circularly-polarized light is −39.2 dB, as shown in FIG. 7A. Hence, the metamaterial film of the present invention has a circular polarization filtering function, namely a function of filtering right-handed circularly-polarized light wave and retaining left-handed circularly-polarized light to pass.

A beam of left-handed circularly-polarized light with the amplitude of 0.5 A and a beam of right-handed circularly-polarized light with the amplitude of 0.5 A can be synthesized into a beam of linearly polarized light wave with the amplitude of A under a certain phase and vibration direction condition. In the embodiment of the present invention, a beam of linearly polarized light waves with the amplitude of A₀ are used as an exciting source, and the output light wave is left-handed circularly-polarized light waves with the amplitude of 0.49 A₀. Hence, the extraction efficiency on the left-handed circularly-polarized light wave in the linearly polarized light is up to 98%, and the output left-handed circularly-polarized light is approximately circularly-polarized light.

In order to illustrate the working mechanism of the optical polarization rotator of the present invention, the coupling response of the embodiment of the present invention will be further analyzed below.

The metal microstructure has the characteristic of chiral symmetry, so when light waves of certain frequencies pass through the metal microstructure, dipole oscillation can be produced. The included angle between the first metal microstructure layer 1 and the second metal microstructure layer 3 enables the oscillation to deflect, namely the polarization of the light wave is changed. Formula of an oscillation circuit is:

$${f}_{0} = \frac{1}{2 π \sqrt{LC}}$$

Thus, the response frequency of the structure is inversely proportional to the inductance L and the capacitance C. In the metamaterial technology, the metal line length of the metamaterial structure represents the inductance of the system, and the opposite area of the metal represents the capacitance of the system, so in the structure of the present invention, the length of the metal arm and the material attribute and thickness of the dielectric substrate layer are related to the response frequency of the metamaterial.

The metal microstructure pattern adopted by the optical polarization rotator has chiral symmetry, the metamaterial film structure of the present invention can produce an electromagnetic coupling effect under the response frequency, and the chiral metal microstructure has dipole response in electromagnetic coupling.

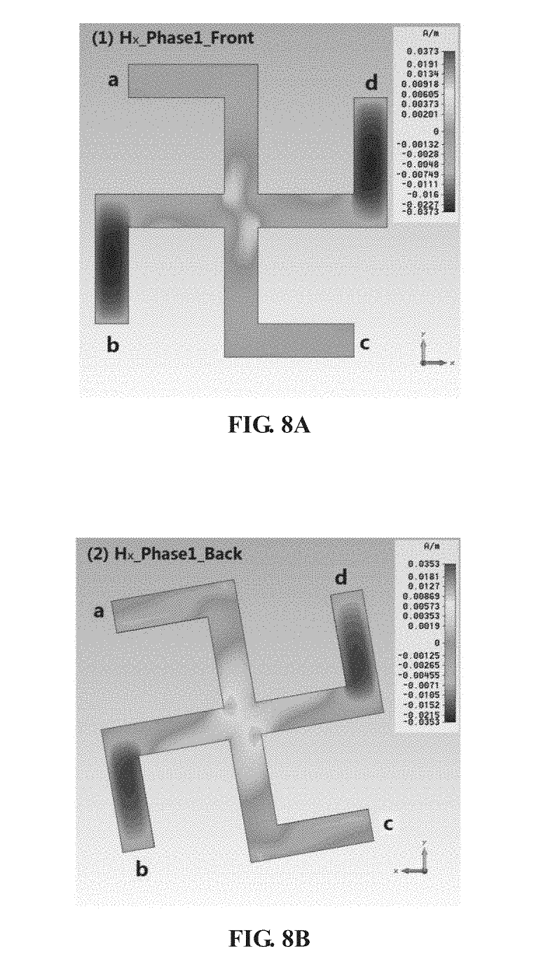

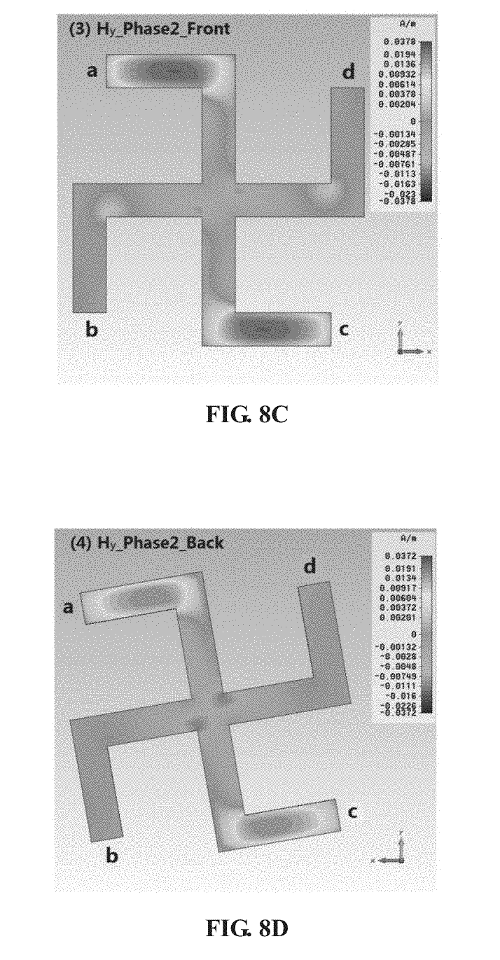

When a beam of linearly polarized light wave with the frequency of 255.9 THz and the polarization direction parallel to the Y axis is vertically incident on the structure, the light wave will produce electromagnetic coupling response in the structure, as shown in FIG. 8A to FIG. 8D, which are mode field distribution diagrams of magnetic field intensity of the first metal surface 1 and the fourth metal surface 4 in coupling response.

When the phase of incident light wave is phase 1 (Phase 1), as shown in FIG. 8A, the magnetic field component Hₓ of the light wave produces electromagnetic oscillation peaks at the metal arm b and the metal arm d in the first metal surface 1; meanwhile, as seen in FIG. 8B, the magnetic field component Hₓ of the light wave also produces electromagnetic oscillation peaks at the metal arm b and the metal arm d in the fourth metal surface 4.

When the phase of the incident light wave is turned to phase 2 (Phase2) (Phase2=Phase1−π/2), as shown in FIG. 8C, the magnetic field component H_{y} of the light wave produces electromagnetic oscillation peaks at the metal arm a and the metal arm c in the first metal surface 1; meanwhile, as shown in FIG. 8D, the magnetic field component H_{y} of the light wave also produces electromagnetic oscillation peaks at the metal arm a and the metal arm c in the fourth metal surface 4.

In the electromagnetic wave coupling response shown in FIG. 8A to FIG. 8D, the mode field distribution is turned from the horizontal direction to the vertical direction, seemingly a TE polarization to TM polarization conversion system, but in fact, FIG. 8A and FIG. 8B are mode field distribution diagrams for the horizontal magnetic field component Hₓ of the light wave produces oscillation peaks at the metal arms b and the metal arms d of the first metal surface 1 and the fourth metal surface 4 at the phase 1 (Phase 1) during coupling; FIG. 8C and FIG. 8D are mode field distribution diagrams for the vertical magnetic field component H_{y} of the light wave produces oscillation peaks at the metal arms a and the metal arms c of the first metal surface 1 and the fourth metal surface 4 at next phase 2 (Phase2) which equals to Phase1−π/2. The amplitudes of the magnetic field components Hₓ and H_{y} are nearly equal when the phase difference of the phase 1 (Phase1) and the phase 2 (Phase2) is π/2, and this alternating mode field distribution indicates that the magnetic vector of the light wave continuously rotates along with the change of the phase within a metal plane.

For a situation that a sinusoidal linearly polarized incident light wave enters the structure of the present invention, according to the mode field distribution shown by the incident first metal surface 1 and the exit fourth metal surface 4 and the same amplitude of the two orthogonal components T_{xy} and T_{yy} as mentioned in FIG. 5, it is shown that the embodiment has obvious optical rotation characteristic on the incident light wave under the coupling frequency, and the electric vector and magnetic vector of the light wave will do left-handed movement along with the propagation of the light wave via the embodiment.

Hence, the embodiment of the present invention can convert linearly polarized light waves into left-handed circularly-polarized light waves, and its overall thickness is only 70 nm, but the ellipticity of the output circularly-polarized light waves is nearly −45°, so the beam quality is good, and the conversion efficiency of the input linearly polarized light waves is up to 98%.

While the invention has been described in terms of various specific embodiments, those skilled in the art will recognize that the invention can be practiced with modification within the spirit and scope of the claims.

1. A left-handed circular-polarization conversion metamaterial film, which is of an optical frequency band metamaterial structure, comprising:
a first metal microstructure layer (1), a dielectric substrate layer (2) and a second metal microstructure layer (3), wherein the first metal microstructure layer (1) and the second metal microstructure layer (3) are attached to the two sides of the dielectric substrate layer (2); an upper surface of said first metal microstructure layer (1) is a first metal surface (1) and a lower surface is a second metal surface (2); the upper surface of said second metal microstructure layer (3) is a third metal surface (3) and the lower surface is a fourth metal surface (4), said first metal surface (1) is an incident surface, and the fourth metal surface (4) is an exit surface; said first metal microstructure layer (1) and said second metal microstructure layer (3) are of chirally-symmetric right-handed windmill structures or spiral chirally-symmetric right-handed artificial structures, left-hand-rotated angle using the structure center as a rotation center is formed between said first metal microstructure layer (1) and said second metal microstructure layer (3), the amplitudes of two orthogonal components of output light waves are equal, and a phase difference of the two orthogonal components is odd times of 90 degrees.

2. The left-handed circular-polarization conversion metamaterial film in claim 1 wherein both the first metal microstructure layer (1) and the second metal microstructure layer (3) are included of a plurality of right-handed gammadion microstructures arranged periodically in an array manner.

3. The left-handed circular-polarization conversion metamaterial film in claim 1 wherein the first metal microstructure layer (1) and the second metal microstructure layer (3) are made of a metallic conductive material or a nonmetallic conductive material.

4. The left-handed circular-polarization conversion metamaterial film in claim 3 wherein the metallic conductive material is gold, silver or copper.

5. The left-handed circular-polarization conversion metamaterial film in claim 3 wherein said nonmetallic conductive material is an indium tin oxide or graphite carbon nano-tubes.

6. The left-handed circular-polarization conversion metamaterial film in claim 1 wherein the thicknesses of both the first metal microstructure layer (1) and the second metal microstructure layer (3) are 30 nm to 100 nm.

7. The left-handed circular-polarization conversion metamaterial film in claim 1 wherein said dielectric substrate layer (2) is made of a polymer.

8. The left-handed circular-polarization conversion metamaterial film in claim 7 wherein the polymer is cyanate, PMMA (Polymethyl Methacrylate), PTFE (Polytetrafluoroethylene) or fluoride.

9. The left-handed circular-polarization conversion metamaterial film in claim 1 wherein the dielectric substrate layer (2) is made of a material having low dielectric constant and low dielectric loss, and the dielectric constant of the material is 1.5 to 2.0.

10. The left-handed circular-polarization conversion metamaterial film in claim 1 wherein a value of dielectric loss tangent of the dielectric substrate layer (2) is less than 0.003.

11. The left-handed circular-polarization conversion metamaterial film in claim 1 wherein the dielectric thickness of the dielectric substrate layer (2) is 20 nm to 100 nm.

12. The left-handed circular-polarization conversion metamaterial film in claim 1 wherein said left-hand-rotated angle of the rotation center is 5° to 22.5°.
